(19) United States
(12) Patent Application Publication
(10) Pub. No.: US 2025/0301104 A1
(43) Pub. Date: Sep. 25, 2025

(54) VEHICLE COMMUNICATION APPARATUS

(71) Applicant: Honda Motor Co., Ltd., Tokyo (JP)

(72) Inventors: Kaede Inoguchi, Tokyo (JP); Sunao Yamaguchi, Tokyo (JP); Kaho Tonomura, Tokyo (JP)

(21) Appl. No.: 19/060,714

(22) Filed: Feb. 23, 2025

(30) Foreign Application Priority Data
Mar. 19, 2024 (JP) 2024-044032

(51) Int. Cl. H04N 7/18

(52) U.S. Cl. CPC H04N 7/183

(57) ABSTRACT

A vehicle communication apparatus includes a microprocessor connected to a first sensor detecting a condition in a cabin of a vehicle and a second sensor detecting a traveling speed or position of the vehicle, and an output device. The microprocessor is configured to perform: detecting occupants riding on the vehicle, based on detection data of the first sensor; detecting a stop of the vehicle based on detection data of the second sensor; and when getting-off of one or more of the occupants and continuation of riding of one or more of the occupants are detected, and the stop of the vehicle is detected, starting wireless communication with the terminal carried by an occupant whose getting-off is detected via a communication module and transmitting a signal requesting a setting for having an output destination of the video signal as the output device to the terminal.

### CROSS-REFERENCE TO RELATED APPLICATION

This application is based upon and claims the benefit of priority from Japanese Patent Application No. 2024-044032 filed on Mar. 19, 2024, the content of which is incorporated herein by reference.

### BACKGROUND

### Technical Field

The present invention relates to a vehicle communication apparatus configured to enable communication inside and outside a vehicle.

### Related Art

As this type of technology, a technology of establishing wireless communication connection between a wireless communication terminal outside a vehicle and an in-vehicle infotainment (IVI) device inside the vehicle and performing communication such as a call has been developed. For example, JP 2002-171336 A discloses a call system in which a person inside a vehicle cabin and a person outside the vehicle cabin have a conversation without using a dedicated vehicle intercom while a vehicle window is closed by switching between a hands-free call and an intercom call between a mobile phone and a hands-free device.

However, the technique disclosed in JP 2002-171336 A only allows a conversation between the vehicle side and the mobile phone, and does not support communication by a video such as an image or a moving image. Therefore, there has been a demand for a mechanism that enables smoother communication by a video.

### SUMMARY

An aspect of the present invention is a vehicle communication apparatus including a microprocessor connected to a first sensor configured to detect a condition in a cabin of a vehicle, a second sensor configured to detect a traveling speed or current position of the vehicle, and an output device provided in the cabin, and a communication module configured to communicate with a terminal capable of outputting a video signal. The microprocessor is configured to perform: detecting a plurality of occupants riding on the vehicle, based on a detection data of the first sensor; detecting a stop of the vehicle based on detection data of the second sensor; and when getting-off of one or more of the plurality of occupants and continuation of riding of one or more of the plurality of occupants are detected, and the stop of the vehicle is detected, starting wireless communication with the terminal carried by an occupant whose getting-off is detected via the communication module and transmitting a signal requesting a setting for having an output destination of the video signal as the output device to the terminal.

### BRIEF DESCRIPTION OF DRAWINGS

The objects, features, and advantages of the present invention will become clearer from the following description of embodiments in relation to the attached drawings, in which:

FIG. 1 is a schematic diagram illustrating an example of an IVI system including a vehicle communication apparatus;

FIG. 2 is a diagram illustrating an operation menu screen;

FIG. 3A is a block diagram illustrating a configuration of a main part of the vehicle communication apparatus;

FIG. 3B is a block diagram illustrating a configuration of a main part of a terminal;

FIG. 3C is a block diagram illustrating a configuration of a main part of a vehicle sensor group and a vehicle cabin camera;

FIG. 3D is a block diagram illustrating a configuration of a main part of an input device and an output device; and

FIG. 4 is a flowchart illustrating a control processing by a program.

### DETAILED DESCRIPTION OF THE INVENTION

An embodiment of the invention will be described below with reference to the drawings.

### <Outline of Vehicle Communication Apparatus>

The vehicle communication apparatus according to the embodiment supports communication between an occupant inside a vehicle cabin of a vehicle such as an automobile and an occupant outside the vehicle cabin from which the occupant has gotten off.

As an example, a plurality of persons (e.g., four persons) including a driver can get on the vehicle. The vehicle communication apparatus enables communication between an occupant remaining in the vehicle cabin and an occupant who got off the vehicle by using a video after some occupants of family members, acquaintances, and the like who have been riding in the vehicle get off the vehicle. For example, “chasing (video)” is performed to introduce a video of the outside of the vehicle obtained by the occupant who got off the vehicle to the occupant in the vehicle cabin, or to convey a favorite video from among the introduced videos by the occupant in the vehicle cabin or the like to the occupant who got off the vehicle. The image outside the vehicle includes an image captured by a terminal used by an occupant who got off the vehicle.

As described in the outline above, the vehicle communication apparatus provides a service that enables smooth communication between the occupant remaining in the vehicle cabin and the occupant who got off the vehicle without causing the occupant to feel troublesome.

In the embodiment, a vehicle communication apparatus is provided as one of the functions of an in-vehicle infotainment (IVI) system provided in a vehicle. Such a vehicle communication apparatus will be described in more detail.

### <System Configuration Example>

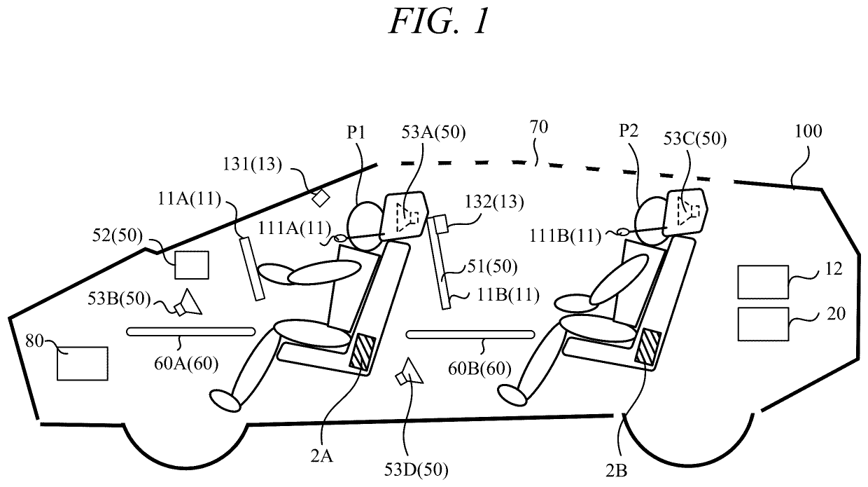

FIG. 1 is a schematic diagram illustrating an example of an IVI system including a vehicle communication apparatus. The IVI system includes a control apparatus 20, a vehicle sensor group 12 of a vehicle 100 serving as a moving body, a display unit 51, a projection unit 52, and voice reproducing units 53A to 53D constituting an output device 50 provided in the vehicle 100, operation detection units 11A and 11B and microphones 111A and 111B constituting an input device 11 provided in the vehicle 100, a front seat camera 131 and a rear seat camera 132 constituting a vehicle cabin camera 13 provided in the vehicle 100, a terminal 2A used by an occupant P1 in a front seat of the vehicle cabin, and a terminal 2B used by an occupant P2 in a rear seat of the vehicle cabin.

The control apparatus 20 and the terminals 2A and 2B are configured to be able to perform wireless communication. The control apparatus 20, the output device 50, the input device 11, the vehicle sensor group 12, and the vehicle cabin camera 13 are configured to be able to perform wired communication by a controller area network (CAN) or the like.

Note that the vehicle 100 includes an air conditioner 80 that adjusts temperature and humidity in the vehicle cabin, a lighting device 70 (which may also be referred to as a dimming sunroof) that can adjust a lighting amount into the vehicle cabin by a dimming glass covering substantially the entire ceiling of the vehicle cabin, and an ambient light 60A for a front seat and an ambient light 60B for a rear seat constituting an illumination device 60.

As an example, the terminals 2A and 2B are configured by a smartphone or the like used by each of the occupants P1 and P2. The terminals 2A and 2B may be held by a holder (not illustrated) installed on a seat on which each person sits.

Although the two terminals 2A and 2B are illustrated as the terminals used by the occupants P1 and P2, the actual number of terminals varies depending on the number of occupants, and is four in a case where there are four occupants. In addition, the number of cameras constituting the vehicle cabin camera 13, the number of operation detection units and microphones constituting the input device 11, and the number of display units, projection units, and voice reproducing units constituting the output device 50 may also be appropriately changed according to the number of occupants.

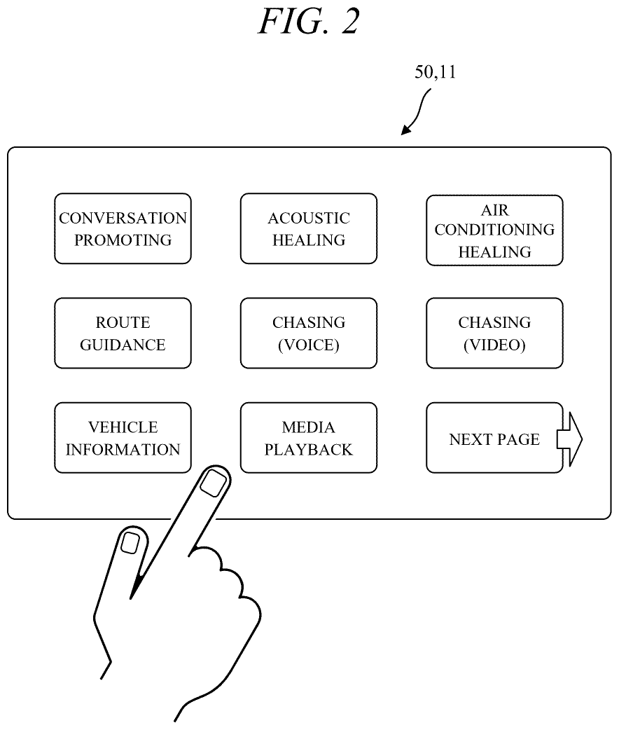

FIG. 2 is a diagram illustrating an operation menu screen of the IVI system of FIG. 1. In the embodiment, the image is projected or displayed on the output device 50 (projection unit 52, display unit 51). When a menu button (which may be referred to as an icon) displayed on the output device 50 is touch operated or a voice corresponding to the menu button is input from the microphones 111A and 111B constituting the input device 11, the control apparatus 20 starts an operation of a function corresponding to the touch operated or the audio input menu.

The operation menu screen illustrated in FIG. 2 includes menu buttons corresponding to a “conversation promoting” function of supporting conversation between occupants of the vehicle 100; an “acoustic healing” function of soothing the occupants by reproduced sounds by the voice reproducing units 53A to 53D; an “air conditioning healing” function of soothing the occupants by using the air conditioner 80; a “route guidance” function of guiding a travel route to a destination; a “chasing (voice)” function of connecting a terminal of an occupant who got off the vehicle 100 and a communication unit (to be described later) of the control apparatus 20 to transmit an external voice to an occupant in the vehicle cabin; a “chasing (video)” function of connecting the terminal of the occupant who got off the vehicle 100 and the communication unit (to be described later) of the control apparatus 20 to transmit an external video to the occupant in the vehicle cabin; a “vehicle information” function of performing function setting of the vehicle 100 and an auxiliary machine operation, and the like, a “media playback” function of reproducing a medium on which content is recorded from the output device 50, and other functions (description is omitted).

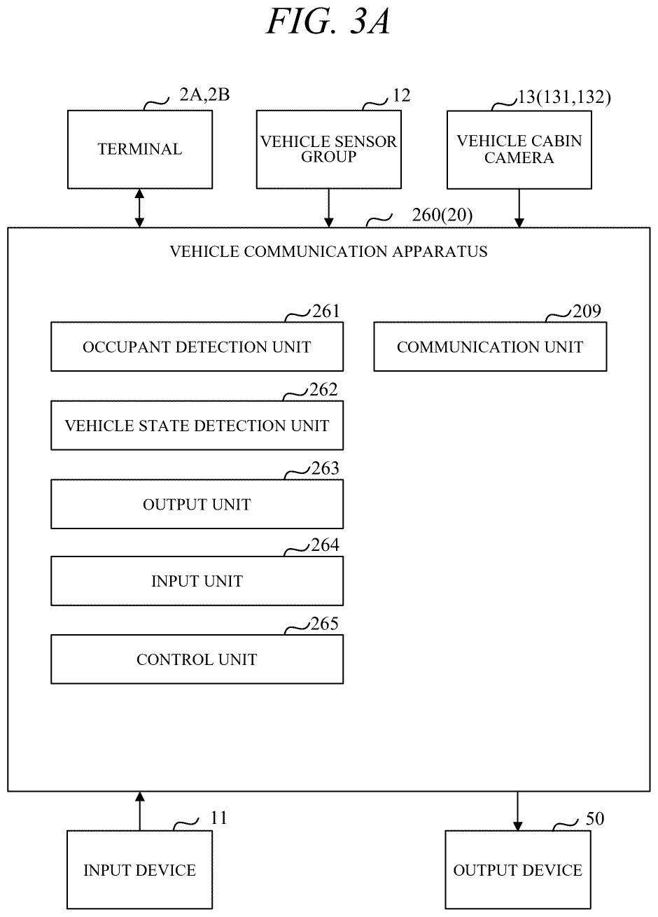

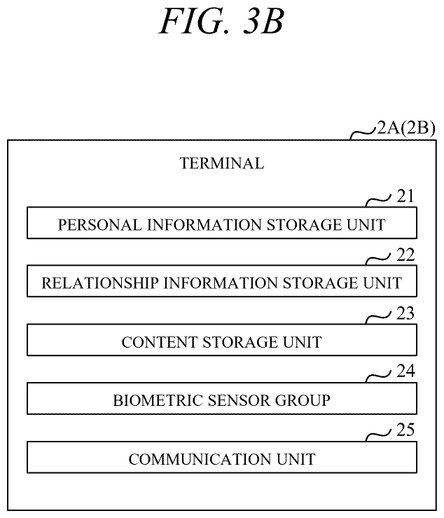

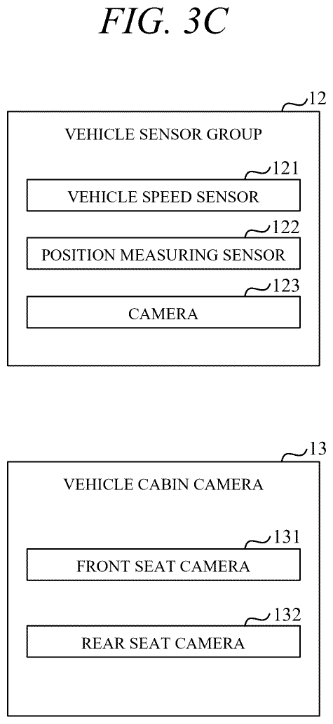

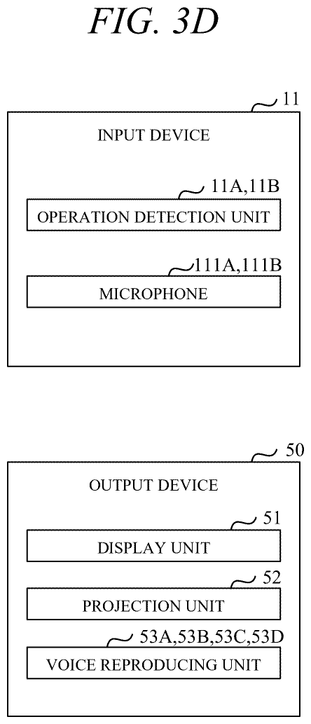

Hereinafter, the function of the control apparatus 20 serving as the vehicle communication apparatus in a case where a “chasing (voice)” button on the operation menu screen is operated will be mainly described. FIGS. 3A to 3D are diagrams describing a configuration example of each unit in FIG. 1.

### <Vehicle Communication Apparatus>

FIG. 3A is a block diagram illustrating a configuration of a main part of the control apparatus 20. The control apparatus 20 includes an arithmetic processing unit such as a micro processing unit (MPU) (not illustrated), and reads and executes a predetermined program stored in a storage unit (not illustrated) to perform various information processing, control processing, and the like necessary for the control apparatus 20.

The control apparatus 20 includes, as a functional configuration for the vehicle communication apparatus 260, an occupant detection unit 261, a vehicle state detection unit 262, an output unit 263, an input unit 264, a control unit 265, and a communication unit 209, and controls the IVI system to function as the vehicle communication apparatus 260.

In the embodiment, as an example, when the occupants P1 and P2 get on the vehicle 100, the control apparatus 20 talks to the occupants P1 and P2 via the voice reproducing units 53A to 53D constituting the output device 50, and collects sounds of the voice response from the occupants P1 and P2 (e.g., stating their own name) with the microphones 111A and 111B constituting the input device 11 and also images the occupants P1 and P2 with the front seat camera 131 and the rear seat camera 132 constituting the vehicle cabin camera 13.

The control apparatus 20 associates (or alternatively, correlates) the faces of the occupants P1 and P2, the names of the occupants P1 and P2, and the frequency components of the voice uttered by the occupants P1 and P2.

### (Occupant Detection Unit)

The occupant detection unit 261 detects a plurality of occupants P1 and P2 riding in the vehicle 100. For example, the occupants P1 and P2 are detected based on camera images acquired by the front seat camera 131 and the rear seat camera 132 constituting the vehicle cabin camera 13.

### (Vehicle State Detection Unit)

The vehicle state detection unit 262 acquires the vehicle speed information and the position information as vehicle information of the vehicle 100 from the vehicle sensor group 12 via the communication unit 209. As a result, the control apparatus 20 can determine whether or not the vehicle 100 is in a stopped state.

### (Output Unit)

The output unit 263 constituting the input/output unit outputs, to the output device 50, a communication signal from a terminal (in this example, 2B) carried by an occupant (e.g., P2) who got off the vehicle, the terminal wirelessly communicating with the communication unit 209. As a result, the occupant (in this example P1) remaining in the vehicle cabin of the vehicle 100 can confirm the communication contents via the nearby output device 50 (projection unit 52 for the occupant P1 and display unit 51 for the occupant P2). More specifically, when the communication signal includes a voice signal, a voice based on the voice signal output from the output unit 263 (control apparatus 20) is reproduced by a voice reproducing unit (in this example, 53A and 53B for the occupant P1).

Furthermore, when the video signal is included in the communication signal, the video based on the video signal output from the output unit 263 (control apparatus 20) is projected by the display unit (in this example, the projection unit 52 for the occupant P1).

When a plurality of videos are continuously transmitted from a terminal (in this example 2B) carried by the occupant (e.g., P2) who got off the vehicle, the output unit 263 may cause the plurality of videos to be projected side by side on the screen of the display unit (in this example, the projection unit 52 for the occupant P1).

The video may include a two-dimensional code. In a case where the two-dimensional code appears in the video from the terminal (in this example, 2B) carried by the occupant (e.g., P2) who got off the vehicle, the output unit 263 may cause an image related to the two-dimensional code to be projected on the screen of the display unit (in this example, the projection unit 52 for the occupant P1). More specifically, when the two-dimensional code includes information indicating a uniform resource locator (URL), the control unit 265 described later acquires a video signal from a server or the like corresponding to the URL via the communication unit 209 described later, and causes a video based on the video signal to be projected by the display unit (in this example, the projection unit 52 for the occupant P1). That is, when the occupant (e.g., P2) who got off the vehicle holds the camera (not illustrated) of the terminal (2B in this example) the occupant is carrying over the two-dimensional code, the occupant (in this example, the occupant P1) of the vehicle 100 can visually recognize the image related to the two-dimensional code on the display unit (in the present example the projection unit 52 for the occupant P1). The image related to the two-dimensional code may be an image introducing a product or the like.

### (Input Unit)

When the operation detection units 11A and 11B are operated by the occupants P1 and P2 while a video signal is being output to the output device 50 (projection unit 52, display unit 51), the input unit 264 constituting the input/output unit inputs a signal indicating an object corresponding to an operation position among predetermined objects (e.g., an object, a person, an icon, a two-dimensional code, etc.) included in a projected or displayed video from the operation detection units 11A and 11B as an instruction for selection by the occupants P1 and P2.

Furthermore, in a case where a plurality of thumbnail images (reduced images in which the size of data is suppressed to be small) are included in the projected or displayed video, the input unit 264 may input a signal indicating a thumbnail image corresponding to the operation position (a signal indicating the position of the thumbnail image on the projected or displayed screen, or a signal indicating the order in which the thumbnail image is projected or displayed) from the operation detection units 11A and 11B as an instruction for selection by the occupants P1 and P2. That is, the occupant (in this example, the occupant P1) of the vehicle 100 views the image introducing the product or the like related to the two-dimensional code on the display unit (in this example, the projection unit 52 for the occupant P1), and can input an instruction to select the favorite product or the like from the operation detection units 11A and 11B.

Furthermore, the input unit 264 may input an instruction by voice uttered by the occupants P1 and P2. More specifically, a voice signal of the occupant P1 in the front seat collected by the microphone 111A is input as an instruction. Furthermore, a voice signal of the occupant P2 in the rear seat collected by the microphone 111B is input as an instruction.

### (Control Unit)

When the occupant detection unit 261 detects, among the plurality of occupants P1 and P2, getting-off of one or more occupants and continuation of riding of one or more occupants, and the vehicle state detection unit 262 detects the stopping of the vehicle 100, the control apparatus 20 serving as the control unit 265 controls the communication unit 209 to wirelessly communicate with a terminal (in this example, 2B) carried by the occupant (e.g., P2) whose getting-off is detected, and controls the communication unit 209 to send a signal requesting setting for having an output destination of the video signal as the output unit 263 to the terminal (in this example 2B) to be wirelessly communicated.

Furthermore, the control unit 265 may acquire terminal position information from a terminal (in this example, 2B) wirelessly communicating with the communication unit 209, and when the distance between the stop position of the vehicle 100 and the position of the terminal (in this example, 2B) indicated by the terminal position information exceeds a predetermined distance (e.g., 200 m), control the communication unit 209 to send a signal requesting cancellation of the setting for having an output destination of the video signal as the output unit 263 to the wirelessly communicating terminal (in this example 2B).

The control unit 265 may further control the communication unit 209 to transmit a voice signal (in this example, a voice signal of the occupant P1 in the front seat collected by the microphone 111A) input to the input unit 264 to the terminal (in this example, 2B), and control the output unit 263 to output a voice signal included in a communication signal from the wirelessly communicating terminal (in this example, 2B) to the output device 50 (in this example, the voice reproducing units 53A and 53B for the occupant P1) and output a video signal included in the communication signal to the output device 50 (in this example, the projection unit 52 for the occupant P1).

Furthermore, the control unit 265 may control the communication unit 209 to transmit the signal indicating the instruction of selection by the occupant P1 input to the input unit 264 to the terminal (in this example, 2B). The signal indicating the instruction of selection may be, for example, a signal indicating the position of the thumbnail image on the projected or displayed screen, the order in which the thumbnail image is displayed, a favorite product, or the like.

### (Communication Unit)

The communication unit 209 includes a communication module. More specifically, the communication unit 209 includes a short-range wireless communication module (not illustrated) that performs wireless communication with the terminals 2A and 2B and a wired communication module (not illustrated) that performs wired communication by CAN or the like. A wireless communication system having a direction detection function may be adopted as the short-range wireless communication module.

### <Terminal>

FIG. 3B is a block diagram illustrating a configuration of a main part of the terminal 2A. Since the configuration of the terminal 2B is similar to that of the terminal 2A, illustration thereof will be omitted. The terminal 2A includes an arithmetic processing unit such as an MPU (not illustrated), and reads and executes a predetermined program (which may also be referred to as an application) stored in a storage unit (not illustrated) to perform various information processing, control processing, and the like necessary for a functional configuration described below.

The terminal 2A includes, as a functional configuration, a personal information storage unit 21, a relationship information storage unit 22, a content storage unit 23, a biometric sensor group 24, and a communication unit 25. In general, a smartphone includes a display unit, an input unit, a voice reproducing unit, a camera, a position detection unit, and the like, but illustration and description thereof are omitted.

Note that the terminal 2A may share a function with another device such as a smart watch (not illustrated).

### (Personal Information Storage Unit)

The personal information storage unit 21 stores personal information of the occupant P1 carrying the terminal 2A. In a case where the IVI system functions as the vehicle communication apparatus 260, the personal information is not required.

### (Relationship Information Storage Unit)

The relationship information storage unit 22 stores relationship level information of the occupant P1 using the terminal 2A. When the relationship level information indicating intimacy between the occupants P1 and P2 in the vehicle cabin is transmitted from the control apparatus 20, the information is stored. In a case where the IVI system functions as the vehicle communication apparatus 260, the relationship level information is not required.

### (Content Storage Unit)

The content storage unit 23 stores content collected by the occupant P1 carrying the terminal 2A or information (e.g., a cloud storage that stores content, a URL of a server that streams and reproduces content, etc.) necessary for reproduction of the content. For example, a content of a sound that the occupant P1 wants to listen to when fatigued may be stored in the content storage unit 23 in advance. The sound content includes voice content and music content.

### (Biometric Sensor Group)

The biometric sensor group 24 includes, for example, a heart rate sensor that acquires a heart rate of the occupant P1 carrying the terminal 2A, a respiration sensor that acquires a respiration rate, a blood flow rate sensor that acquires a blood flow rate, and a skin electrical resistance sensor that acquires a skin electrical resistance value (all not illustrated). In a case where the IVI system functions as the vehicle communication apparatus 260, the biometric information collected by the biometric sensor group 24 is not necessary.

### (Communication Unit)

The communication unit 25 includes a short-range wireless communication module (not illustrated) that performs wireless communication with the control apparatus 20 and a wired communication module (not illustrated) that performs wired communication by CAN or the like. The communication unit 25 transmits the video signal, which is acquired by an unillustrated camera provided in the terminal 2A, to the designated output destination based on a command from the control apparatus 20. This command includes a signal requesting a setting in which the output destination of the video signal is the control apparatus 20 (more specifically, the output unit 263). The communication unit 25 sets the output destination of the video signal in accordance with this signal requesting the setting.

FIG. 3C is a block diagram illustrating a configuration of a main part of the vehicle sensor group 12 and the vehicle cabin camera 13 of the vehicle 100.

### <Vehicle Sensor Group>

The vehicle sensor group 12 includes a vehicle speed sensor 121, a position measuring sensor 122, and a camera 123. In general, an acceleration sensor, a radar, and the like are mounted on the vehicle 100 as sensors, but illustration and description thereof are omitted.

### (Vehicle Speed Sensor)

The vehicle speed sensor 121 detects a vehicle speed of the vehicle 100 and outputs vehicle speed information to the control apparatus 20. In a case where the IVI system functions as the vehicle communication apparatus 260, the vehicle speed information is used to determine whether or not the vehicle 100 is in a stopped state.

### (Position Measuring Sensor)

The position measuring sensor 122 detects the current position of the vehicle 100 based on position measuring signals from global positioning system (GPS) satellites, quasi-zenith satellites, or the like. The position measuring sensor 122 outputs a signal indicating the current position to the control apparatus 20 as position information. In a case where the IVI system functions as the vehicle communication apparatus 260, the information on the current position is used to determine whether or not the vehicle 100 is in a stopped state.

### (Camera)

The camera 123 images the surroundings of the vehicle 100. The camera 123 outputs the data of a subject image to the control apparatus 20 as image information. The camera 123 can capture a still image or a moving image. In a case where the IVI system functions as the vehicle communication apparatus 260, image information around the vehicle 100 is not necessary.

### <Vehicle Cabin Camera>

The vehicle cabin camera 13 includes the front seat camera 131 and the rear seat camera 132. The front seat camera 131 images the upper body of the occupant P1 sitting in the front seat, and outputs data of the subject image to the control apparatus 20 as image information. The rear seat camera 132 images the upper body of the occupant P2 sitting in the rear seat, and outputs data of the subject image to the control apparatus 20 as image information.

FIG. 3D is a block diagram illustrating a configuration of a main part of the input device 11 and the output device 50 of the control apparatus 20 of the vehicle 100.

### <Input Device>

The input device 11 includes operation detection units 11A and 11B and microphones 111A and 111B.

### (Operation Detection Unit)

The operation detection unit 11A is operated by the occupant P1 in the front seat, and outputs an operation signal to the control apparatus 20. The operation detection unit 11A may be configured as a pointing device that interlocks with a projection image projected by the projection unit 52 described later. The operation detection unit 11B is provided on the display surface of the display unit 51. The operation detection unit 11B is operated by the occupant P2 in the rear seat and outputs an operation signal indicating a touch position to the control apparatus 20.

### (Microphone)

The microphone 111A collects a voice uttered by the occupant P1 in the front seat and outputs a voice signal to the control apparatus 20. The microphone 111B collects a voice uttered by the occupant P2 in the rear seat and outputs a voice signal to the control apparatus 20.

### <Output Device>

The output device 50 includes the display unit 51, the projection unit 52, and the voice reproducing unit 53. The output device 50 is used, for example, for display of the operation menu screen in FIG. 2, video display in a case where a video signal is included in a communication signal of the vehicle communication apparatus 260, reproduction of content, or the like.

The video signal is output from the output unit 263 (control apparatus 20) described above.

The content may be acquired from the terminals 2A and 2B carried by the plurality of occupants P1 and P2 in the vehicle cabin via the communication unit 209. The content may be acquired not only from the terminals 2A and 2B but also from an external content management server via a communication network (not illustrated). The content management server includes a cloud storage configured to store content and a streaming server configured to reproduce content. The content is searched for and acquired by the control apparatus 20 via the communication unit 209.

Note that the content may be video content (moving image, still image, text display, icon display, graphic display, etc.) or sound content.

### (Display Unit)

The display unit 51 has a screen such as a liquid crystal display, and displays image information based on a display signal output from the control apparatus 20. The image information includes the operation menu screen of FIG. 2, a video from a terminal (in this example 2B) with which the communication unit 209 performs wireless communication, an image of the video content, and the like.

### (Projection Unit)

The projection unit 52 includes, for example, a head-up display (HUD) to be projected on a windshield or the like, and projects image information based on a projection signal output from the control apparatus 20. The image information includes the operation menu screen of FIG. 2, a video from a terminal (in this example 2B) with which the communication unit 209 performs wireless communication, an image of the video content, and the like.

### (Voice Reproducing Unit)

The voice reproducing units 53A to 53D are configured as speakers configured to reproduce and output voice and the like, and reproduce content of voice, sound, and the like from a terminal (in this example, 2B) with which the communication unit 209 wirelessly communicates based on a reproduction signal output from the control apparatus 20. Note that a voice output unit that outputs a content reproduction signal to a headphone (not illustrated) or the like may be provided.

### <Description of Flowchart>

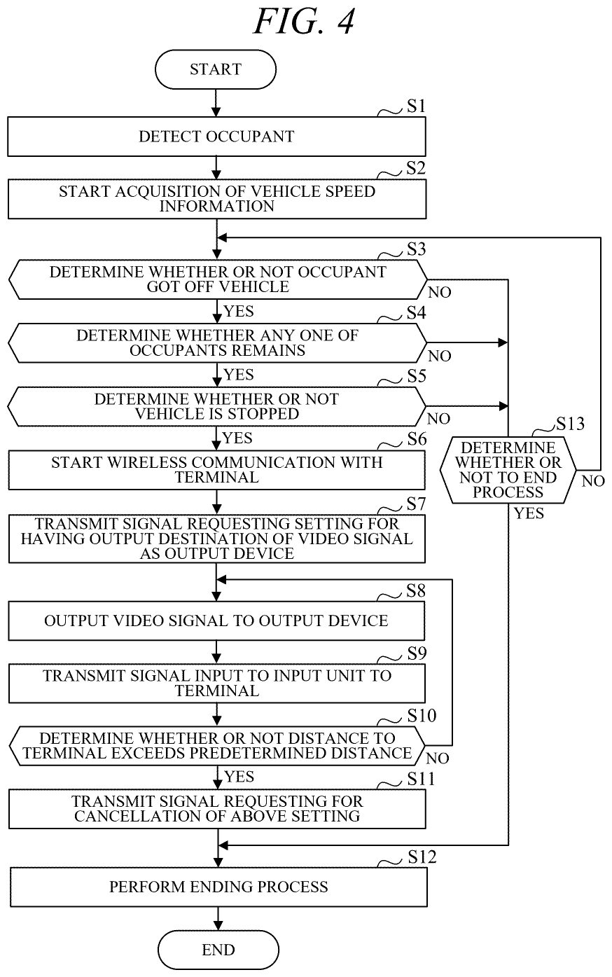

FIG. 4 is a flowchart illustrating an example of control processing by a program executed by the MPU of the control apparatus 20. When the “chasing (voice)” button is operated on the operation menu screen in FIG. 2, the MPU of the control apparatus 20 executes a program for performing the processing illustrated in FIG. 4 to cause the IVI system to function as the vehicle communication apparatus 260. The control apparatus 20 functions as the control unit 265 of the vehicle communication apparatus 260 during execution of the program.

In step S1 of FIG. 4, the control apparatus 20 causes the occupant detection unit 261 to detect the occupants P1 and P2 riding in the vehicle 100, and proceeds to step S2. Note that for the detection of the occupants P1 and P2, a method using a seating sensor, a method of detecting the terminals 2A and 2B carried by the occupants P1 and P2 in the vehicle cabin, and the like may be adopted other than the method using the camera image acquired by the vehicle cabin camera 13 (which may be referred to as a driver monitoring camera (DMC)) described above.

In step S2, the control apparatus 20 causes the vehicle state detection unit 262 to start acquisition of vehicle speed information and position information as vehicle information of the vehicle 100, and proceeds to step S3.

In step S3, the control apparatus 20 determines whether or not the occupants P1 and P2 got off the vehicle based on the detection result of the occupant detection unit 261. The control apparatus 20 makes an affirmative determination in step S3 that at least one person is determined to have gotten off the vehicle and proceeds to step S4, and makes a negative determination in step S3 that no person has gotten off the vehicle and proceeds to step S13.

In step S4, the control apparatus 20 determines whether any one of the occupants P1 and P2 remains in the vehicle cabin based on the detection result of the occupant detection unit 261. The control apparatus 20 makes an affirmative determination in step S4 that at least one person remains in the vehicle cabin and proceeds to step S5, and makes a negative determination in step S4 when there are no occupants P1 and P2 present in the vehicle cabin and proceeds to step S13.

In step S5, the control apparatus 20 determines whether or not the vehicle 100 is stopped based on the detection result by the vehicle state detection unit 262. The control apparatus 20 makes an affirmative determination in step S5 that the vehicle 100 is stopped, and proceeds to step S6. In a case where the vehicle 100 is not stopped, the control apparatus 20 makes a negative determination in step S6 and proceeds to step S13.

In step S13 to which the process proceeds when step S3, S4, or S5 is determined, the control apparatus 20 determines whether or not to end the control process. The control apparatus 20 makes an affirmative determination in step S13 and proceeds to step S12 in a case where a predetermined ending operation is performed, and makes a negative determination in step S13 and returns to step S3 in a case where the ending operation is not performed. In the case of returning to step S3, the control apparatus 20 repeats the above-described processing. That is, the control apparatus 20 waits for the getting-off of the occupants P1 and P2.

In step S6, the control apparatus 20 causes the communication unit 209 to start wireless communication with a terminal outside the vehicle (in this example, the terminal 2A or 2B) carried by the occupant P1 or P2 who got off the vehicle, and proceeds to step S7.

In step S7, the control apparatus 20 causes the communication unit 209 to transmit a signal requesting a setting for having an output destination of the video signal as the output device 50 of the vehicle 100 to a terminal (in this example, the terminal 2A or 2B) outside the vehicle carried by the occupant P1 or P2 who got off the vehicle, and proceeds to step S8.

In step S8, the control apparatus 20 causes the output unit 263 to output the video signal acquired from the terminal outside the vehicle (in this example, the terminal 2A or 2B) to the output device 50, and proceeds to step S9.

In step S9, the control apparatus 20 causes the communication unit 209 to transmit a signal indicating the instruction of the occupant P1 or P2 in the vehicle cabin input to the input unit 264 to a terminal outside the vehicle (in this example, the terminal 2A or 2B), and proceeds to step S10.

In step S10, the control apparatus 20 causes the control unit 265 to determine whether or not the distance from the vehicle 100 to the terminal outside the vehicle (in this example, the terminal 2A or 2B) exceeds a predetermined distance. When the distance between the stop position of the vehicle 100 and the position of the terminal indicated by the terminal position information from the terminal 2A or 2B exceeds a predetermined distance, the control unit 265 makes an affirmative determination in step S10, and proceeds to step S11. In a case where the process proceeds to step S11, the process automatically proceeds to the ending process regardless of the predetermined ending operation.

On the other hand, when the distance between the stop position of the vehicle 100 and the position of the terminal 2A or 2B does not exceed the predetermined distance, the control unit 265 makes a negative determination in step S10, and returns to step S8. In a case where the process returns to step S8, the control unit 265 continues wireless communication (chasing (video)) between the communication unit 209 and a terminal outside the vehicle (in this example, the terminal 2A or 2B).

In step S11, the control apparatus 20 causes the communication unit 209 to transmit a signal requesting for cancellation of a setting for having the output destination of the video signal as the output device 50 of the vehicle 100 to a terminal (in this example, the terminal 2A or 2B) outside the vehicle carried by the occupant P1 or P2 who got off the vehicle, and proceeds to step S12.

In step S12, the control apparatus 20 performs the ending process and ends the process according to FIG. 4. The ending process includes, as an example, ending of output of a video signal to the output device 50 and ending of wireless communication (chasing (voice)) with a terminal outside the vehicle (in this example, the terminal 2A or 2B) by the communication unit 209.

According to the embodiment described above, the following effects are obtained.
(1) The vehicle communication apparatus 260 includes an occupant detection unit 261 configured to detect a plurality of occupants P1 and P2 riding in the vehicle 100 based on detection data (camera image) of the vehicle cabin camera 13, a communication unit 209 configured to be able to wirelessly communicate with one or more terminals 2A and 2B among the terminals 2A and 2B carried by the plurality of occupants P1 and P2, a vehicle state detection unit 262 configured to detect a stop of the vehicle 100 based on detection data (vehicle speed information) of a vehicle speed sensor 121 or detection data (position information) of a position measuring sensor 12, an input unit 264 serving as an input/output unit configured to output a video signal from the terminal 2A or 2B wirelessly communicating with the communication unit 209 and configured to be able to input an instruction of the occupant P1 or P2, and a control unit 265 configured to, when the occupant detection unit 261 detects getting-off of one or more of the plurality of occupants P1 and P2 and continuation of riding of one or more of the plurality of occupants P1 and P2, and the vehicle state detection unit 262 detects the stop of the vehicle 100, control the communication unit 209 to wirelessly communicate with a terminal 2A or 2B carried by an occupant P1 or P2 whose getting-off is detected and to send a signal requesting for a setting for having an output destination of a video signal as an output unit 263 (output device 50) serving as an input/output unit to a terminal 2A or 2B to be wirelessly communicated. The terminals 2A and 2B each include a capturing device (camera). The video signal includes a video signal acquired by the camera of the terminal and representing a captured image of the occupant carrying the terminal.

With this configuration, when (i) no one got off the vehicle 100, (ii) all the occupants P1 and P2 got off the vehicle 100, or (iii) the vehicle 100 started to run, the terminal 2A or 2B carried by the occupant P1 or P2 whose getting-off is detected and the communication unit 209 of the vehicle 100 do not wirelessly communicate with each other. That is, while preventing unnecessary communication connection, the communication unit 209 and a terminal outside the vehicle (in the embodiment, the terminal 2A or 2B) perform wireless communication (chasing (video)), and communication using the video is performed between the occupant remaining in the vehicle cabin and the occupant who got off the vehicle. In this manner, smooth communication can be performed without causing the occupant to feel troublesome.
(2) In the vehicle communication apparatus 260, the vehicle state detection unit 262 further detects a stop position of the vehicle 100, and the control unit 265 acquires the terminal position information from the terminal 2A or 2B wirelessly communicating with the communication unit 209, and when the distance between the stop position of the vehicle 100 and the position indicated by the terminal position information exceeds a predetermined distance, controls the communication unit 209 to send a signal requesting for cancellation of the setting of having the output destination of the video signal as the output unit 263 serving as the input/output unit to the wirelessly communicating terminal 2A or 2B.

With this configuration, when the occupant P1 or P2 whose getting-off is detected moves and moves away from the vehicle 100 by greater than or equal to a predetermined distance, the setting is automatically canceled in the vehicle communication apparatus 260 on the vehicle 100 side. As a result, it is possible to prevent a video from the terminal 2A or 2B of the occupant P1 or P2 outside the vehicle from being continuously projected or displayed on the display unit (projection unit 52 for the occupant P1 and display unit 51 for the occupant P2).
(3) In the vehicle communication apparatus 260, when an instruction of the occupant P1 or P2 for the video based on the video signal is input to the input unit 264 serving as the input/output unit via the input device 11 while the output unit 263 serving as the input/output unit is outputting the video signal from the terminal 2A or 2B to the output device 50, the communication unit 209 is controlled to transmit a signal indicating the input instruction to the wirelessly communicating terminal 2A or 2B.

With this configuration, communication support using a video between the occupant remaining in the room (in this example, the occupant P1) and the occupant who got off the vehicle (in this example, the occupant P2) is performed. As a result, the occupant remaining in the room and the occupant who got off the vehicle can smoothly communicate with each other using the video.

The above embodiments can be modified in various manners. Hereinafter, modified examples will be described.

### First Modified Example

In the above-described embodiment, an example has been described in which the vehicle communication apparatus 260 wirelessly communicates with the terminal 2B carried by one occupant (e.g., P2) who got off the vehicle via the communication unit 209. Instead, in a case where multiple occupants got off the vehicle (however, there are one or more occupants staying in the vehicle.), each terminal carried by each occupant, that is, a plurality of terminals, and the vehicle communication apparatus 260 can be communicably connected to each other via the communication unit 209.

According to the first modified example, even when a plurality of occupants who got off the vehicle move in different directions from the vehicle 100, communication between each occupant and an occupant staying in the vehicle can be supported.

### Second Modified Example

In the above-described embodiment, in step S10, when the distance between the stop position of the vehicle 100 and the position indicated by the terminal position information exceeds the predetermined distance, the vehicle communication apparatus 260 proceeds to step S11 and transmits a signal requesting for cancellation of the setting for having the output destination of the video signal as the output device 50 of the vehicle 100 to the wirelessly communicating terminal 2A or 2B. However, there is a case where the vehicle 100 starts to run after starting wireless communication with the terminal 2A or 2B in step S6. In this case, in step S10, whether or not the distance between the traveling position of the vehicle 100 detected based on the detection data (position information) of the position measuring sensor 12 and the position indicated by the terminal position information exceeds a predetermined distance may be determined.

### Third Modified Example

In the above-described embodiment, an example in which four people including the driver ride in the vehicle cabin has been described, but the number of occupants is not limited to four, and may be six or 10.

### Fourth Modified Example

In the above-described embodiment, the first modified example, the second modified example, and the third modified example, the vehicle 100 serving as a moving body has been exemplified as an example of a vehicle cabin that supports communication by the vehicle communication apparatus 260, but a cabin of a moving body on which a plurality of occupants board may be handled in the same manner as the above-described vehicle cabin.

The above embodiment can be combined as desired with one or more of the above modifications. The modifications can also be combined with one another.

According to the present invention, smoother communication can be performed.

Above, while the present invention has been described with reference to the preferred embodiments thereof, it will be understood, by those skilled in the art, that various changes and modifications may be made thereto without departing from the scope of the appended claims.

What is claimed is:

1. A vehicle communication apparatus comprising
a microprocessor connected to a first sensor configured to detect a condition in a cabin of a vehicle, a second sensor configured to detect a traveling speed or current position of the vehicle, and an output device provided in the cabin, and
a communication module configured to communicate with a terminal capable of outputting a video signal, wherein
the microprocessor is configured to perform:
detecting a plurality of occupants riding on the vehicle, based on detection data of the first sensor;
detecting a stop of the vehicle based on detection data of the second sensor; and
when getting-off of one or more of the plurality of occupants and continuation of riding of one or more of the plurality of occupants are detected, and the stop of the vehicle is detected, starting wireless communication with the terminal carried by an occupant whose getting-off is detected via the communication module and transmitting a signal requesting a setting for having an output destination of the video signal as the output device to the terminal.

2. The vehicle communication apparatus according to claim 1, wherein
the terminal includes a capturing device, and
the video signal includes a video signal acquired by the capturing device and representing a captured image of the occupant carrying the terminal.

3. The vehicle communication apparatus according to claim 1, wherein
the microprocessor is configured to further perform:
detecting a stop position of the vehicle, based on the detection data of the second sensor;
acquiring terminal position information from the terminal; and
when a distance between the stop position of the vehicle and a position of the terminal indicated by the terminal position information exceeds a predetermined distance, transmitting a signal requesting cancellation of the setting of having the output destination of the video signal as the output device.

4. The vehicle communication apparatus according to claim 1, wherein
the microprocessor is further connected to an input device;
the microprocessor is configured to further perform
when an instruction from the occupant regarding a video based on the video signal is input via the input device while the video signal from the terminal is being output to the output device, transmitting a signal indicating the instruction to the terminal.
